(19) United States
(12) Patent Application Publication
(10) Pub. No.: US 2009/0113782 A1
(43) Pub. Date: May 7, 2009

(54) Universal fishing rod safety grip

(76) Inventor: Joseph Earl Driggers, Bethlehem, GA (US)

Correspondence Address: Joseph Earl Driggers, 1244 Persimmon Place Drive, Bethlehem, GA, 30620, US

(21) Appl. No.: 12/287,819

(22) Filed: Oct. 15, 2008

Related U.S. Application Data
(60) Provisional application No. 61/001,649, filed on Nov. 5, 2007.

(51) Int. Cl. A01K 87/08

(52) U.S. Cl. 43/23

(57) ABSTRACT

No fishing rods have any way to keep them from flying out of your hand while casting. With my Universal Fishing Rod Safety Grip it makes your grasp on the fishing rod handle more secure.

### SPECIFICATION OF DESCRIPTION OF DRAWING

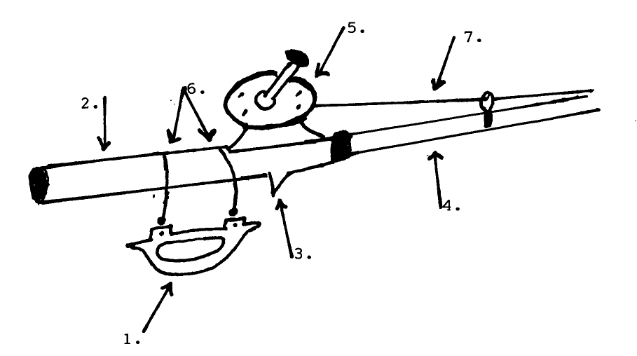

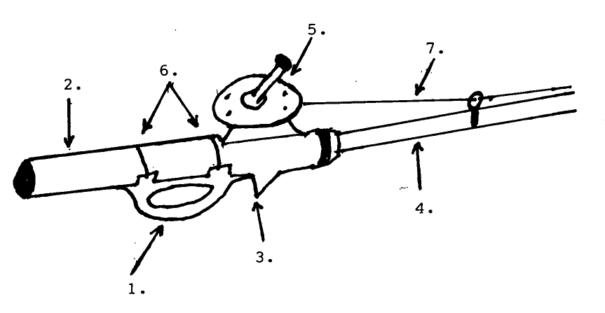

My invention is a plastic or hard rubber material in the shape of a lever that can be made into a fishing rod handle or mounted on any fishing rod handle on the bottom side of the rod handle behind the trigger. FIGS. 1 and 2 Numbers 1 through 7
1. This shows in the drawing what is new on a fishing rod handle. This is my Universal Fishing Rod Safety Grip Lever Invention.
2. This is the fishing rod handle.
3. This is the trigger on the rod handle.
4. This is the fishing rod.
5. This is the fishing reel.
6. This is two plastic tie straps to hold my Universal Fishing Rod Safety Grip on any fishing rod.
7. This is the fishing line.

### BRIEF SUMMARY

No fishing rods have any way to keep them from flying out of your hand while casting. With my Universal Fishing Rod Safety Grip it makes your grasp on the fishing rod handle more secure.

### BACKGROUND HISTORY

Is very simple, without using my fishing rod safety grip I was dropping expensive fishing rods and reels into the lake while casting my line. This is why I came up with this invention.

1. I claim a fishing rod device connected to the handle of a fishing rod. This device can be made very easy out of hard plastic or rubber. It is the shape of a rectangular rounded lever. To be connected to the bottom of the rod handle with two plastic tie straps or can be made into a rod handle. This device helps your grip on the rod handle to keep it in your hand.
